(19) United States
(12) Patent Application Publication
(10) Pub. No.: US 2021/0046394 A1
(43) Pub. Date: Feb. 18, 2021

(54) "Do Not Forget The Baby!" SAFETY BEAR

(71) Applicants: Henry Liddell, JR., Shaw, MS (US); Betsy Brown Liddell, Shaw, MS (US)

(72) Inventors: Henry Liddell, JR., Shaw, MS (US); Betsy Brown Liddell, Shaw, MS (US)

(21) Appl. No.: 16/538,730

(22) Filed: Aug. 12, 2019

(51) Int. Cl. A63H 3/28; A63H 3/02; G08B 21/24

(52) U.S. Cl. CPC A63H 3/28; G08B 21/24; A63H 3/02

(57) ABSTRACT

A safety bear device that communicates with a remote-control bear device to remind the driver that a child is on the back seat of the vehicle. It hangs from the rear view mirror with a hook and cord (option 1), or Velcro to the dashboard (option 2), comprising of distinctive features such as flashing eyes when activated, a voice box that beeps and talks, a sensor to reset safety and remote-control bear devices that beeps 6 feet away from the vehicle operated by a battery. The safety bear and remote-control bear devices are designed to save lives and works in all vehicles.

### SUMMARY

The “Do Not Forget the Baby!” SAFETY BEAR invention is one of a kind. The SAFETY BEAR hangs on the rear-view mirror or is Velcro to the dash-board to remind the driver that a baby is in the vehicle. The SAFETY BEAR is plugged into the car charger and communicates with the remote-control switch and is a feet away from the SAFETY BEAR, the SAFETY BEAR eyes will flash, it will began to beep and then it talks to the driver. When the driver is out the vehicle, the remote-control bear will beep until the driver push the button to turn off the remote-control bear and this will reset the unit.

The driver has multiple reminders to get the baby out of the vehicle. With these many reminders it will definitely save the babies life from dying in a hot or freezing cold vehicle.

### BRIEF DESCRIPTION

In the following portion of the present description, the teachings of the present application will be explained in more detail with reference to the example embodiments shown in the drawings in which:

FIG. 1 is an isometric view of a SAFETY BEAR according to a first embodiment.

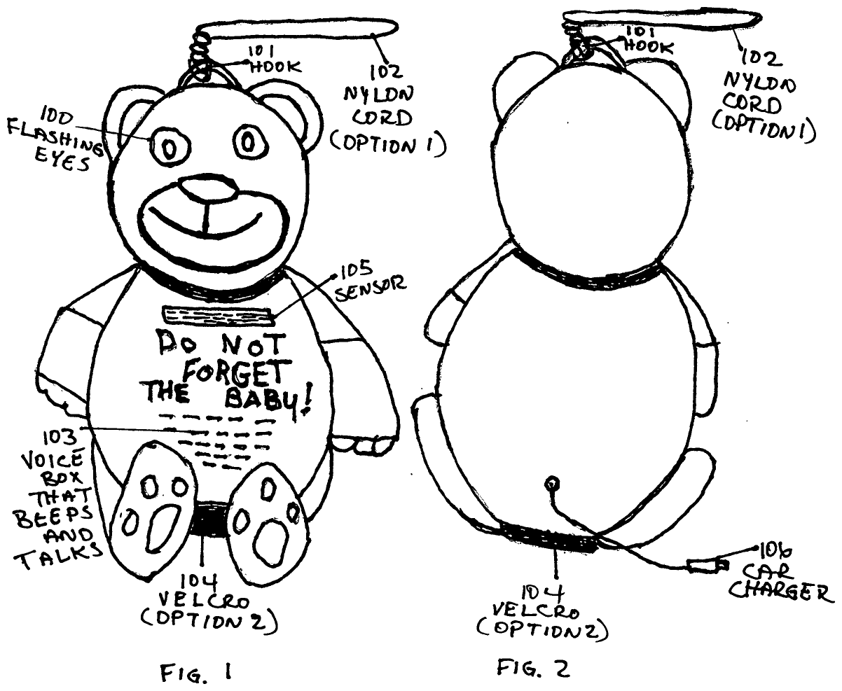

FIG. 2 is an isometric view of a SAFETY BEAR according to a second embodiment.

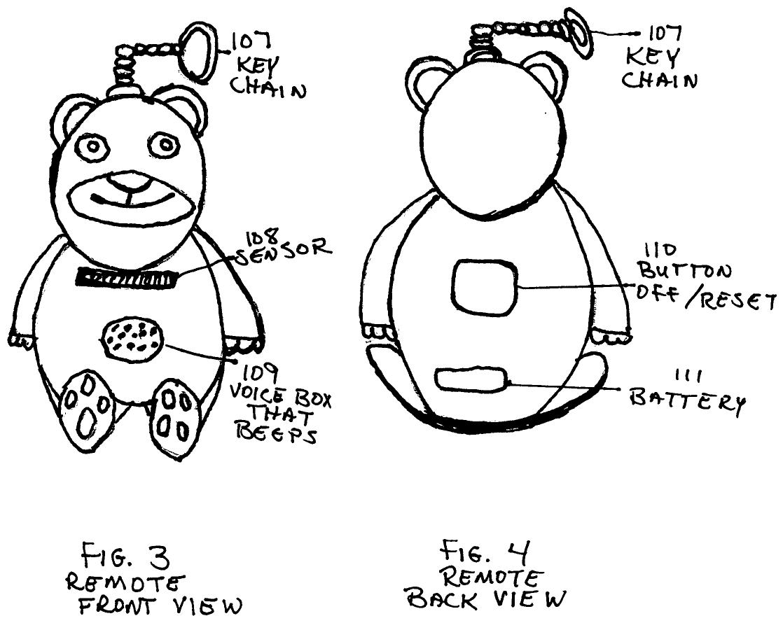

FIG. 3 is an isometric view of a SAFETY BEAR according to a third embodiment.

FIG. 4 is an isometric view of a SAFETY BEAR according to a fourth embodiment.

### DETAIL DESCRIPTION

In the following detailed description, the object according to the teachings for this application in the form of a SAFETY BEAR and remote-control bear will be described by the embodiments.

A first embodiment that's illustrated in FIG. 1 is 100, the flashing eyes, which is one of the features and 103, the voice box, that's programmed to beep and talk. This feature will be available in one of three languages (English, Spanish and Chinese). The driver will have an option to hang the SAFETY BEAR with 101, hook, and 102, nylon cord or to mount it to the dashboard with 104, Velcro. There will be a 105, sensor, to communicate with FIG. 3. FIG. 1 and FIG. 2 will be powered by a 106, car charger, that plugs into the cigarette lighter of any vehicle, new or used.

In this embodiment that's illustrated in FIG. 3 has a 109, voice box, that's programmed to beep as a reminder until the driver press the 110. off/reset button in FIG. 4. It's attached to the keys with a 107, key chain. FIG. 3 also has a 108, sensor that communicates with FIG. 1

The embodiment of FIG. 4 comes with a 111, battery, as a power source.

The “Do Not Forget the Baby!” SAFETY BEAR is one of a kind. It serves as a reminder to the driver that their baby, (infant, toddler, small child, or a child that's physically or mentally challenged), is in the vehicle.

The SAFETY BEAR, itself, being a bear and wearing a “Do Not Forget the Baby!” T-shirt serves as reminders. Not only that, when the driver takes their keys out of the ignition the SAFETY BEAR eyes will start flashing and the SAFETY BEAR will beep 3 times, then talk, beep 3 times and talk again, while the eyes are flashing to remind the driver “Do Not Forget The Baby!” When the driver closes their door and began to walk away, the bear remote control is programmed to beep as another reminder. It will beep until it is turned off by the driver.

The driver has multiple reminders to remove their baby from the back seat. The “Do Not Forget the Baby!” SAFETY BEAR is designed to save lives and to serve as a reminder to the driver.

In 2019, there has been over 20 hot car deaths, ranging from ages 3 mos. To 13 years old. The “Do Not Forget the Baby!” SAFETY BEAR will eliminate this tragedy!

1. A safety bear device that communicates with a remote-control bear to remind the driver that a child, is on the back seat of the vehicle.

2. A safety bear device, according to claim 1 that hangs from the rearview mirror with a hook and cord, (option 1), or is Velcro to the dashboard (option 2).

3. A safety bear device according to claim 1, comprising of distinctive features such as flashing eyes when activated.

4. A safety bear device according to claim 3, wherein a voice box that beeps and talks, when activated.

5. A safety bear device according to claim 1, wherein a sensor is used to reset and turns off claim 1 safety bear device.

6. A safety bear device according to claim 1, wherein a car charger is the power source.

7. A remote-control bear device that communicates with claim 1 safety bear device.

8. A remote-control bear device, according to claim 7, wherein the device beeps when 6 feet away from claim 1 safety bear.

9. A remote-control bear device according to claim 7, comprising of distinctive features such as a key chain design.

10. A remote-control bear device according to claim 7, wherein a sensor is used to communicate with claim 1 safety bear device.

11. A remote-control bear device according to claim 7, comprises of button to turn off claim 7 remote control bear and claim 1 safety bear devices.

12. A remote-control bear device according to claim 7, wherein the device is powered by a battery.

13. A safety bear device according to claim 1, with remote control bear device that works in all vehicle.
